(19) United States
(12) Patent Application Publication
(10) Pub. No.: US 2016/0189173 A1
(43) Pub. Date: Jun. 30, 2016

(54) METHODS AND APPARATUS TO PREDICT ATTITUDES OF CONSUMERS

(71) Applicant: THE NIELSEN COMPANY (US), LLC, Schaumburg, IL (US)

(72) Inventors: Michael King, North Aurora, IL (US); Paul Bell, Chicago, IL (US); Brett Morgner Baden, Chicago, IL (US); Joshua Hurwitz, Niles, IL (US)

(21) Appl. No.: 14/586,434

(22) Filed: Dec. 30, 2014

(51) Int. Cl. G06Q 30/02

(52) U.S. Cl. CPC G06Q 30/0201

(57) ABSTRACT

Methods, apparatus, systems and articles of manufacture to predict attitudes of consumers are disclosed. An example method includes obtaining purchasing behavior data associated with a consumer and obtaining product review data associated with a plurality of reviewers. The example method also includes identifying a set of reviewers from the plurality of reviewers based on a strength of relationship between each of the plurality of reviewers and the consumer. The example method further includes predicting, using a processor, an attitude of the consumer based on the product review data associated with the set of reviewers.

### FIELD OF THE DISCLOSURE

This disclosure relates generally to market analysis, and, more particularly, to methods and apparatus to predict attitudes of consumers.

### BACKGROUND

With the rise of the Internet, venues have developed where people may provide reviews, ratings, and/or opinions of products they have purchased. Some websites that are focused on selling products enable online shoppers to submit reviews of the products they have purchased. In such examples, the submitted reviews may be posted for other online customers to see and consider. Some other websites may not sell products but are focused on aggregating and providing reviews of products purchased elsewhere (whether online or in a brick-and-mortar store). The rise of venues that enable consumers to express their views has expanded to cover almost any type of product including both goods and services.

### BRIEF DESCRIPTION OF THE DRAWINGS

FIG. 1 is a schematic illustration of an example environment in which the teachings disclosed herein may be implemented.

FIG. 2 is a block diagram of an example implementation of the example data processing facility of FIG. 1.

FIGS. 3-6 are flowcharts representative of example machine readable instructions that may be executed to implement the example data processing facility of FIGS. 1 and/or 2.

FIG. 7 is a block diagram of an example processor platform capable of executing the example machine readable instructions of FIGS. 3-6 to implement the example data processing facility of FIGS. 1 and/or 2.

### DETAILED DESCRIPTION

Many businesses (e.g., manufacturers, retailers, etc.) and advertisers try to increase demand for their goods or services by influencing the behavior of target consumer segments through advertising campaigns. Often businesses will try to improve their marketing efforts by targeting specific consumer segments. However, identifying such segments can be difficult. Segmentation solutions often lack breadth based on a lack of sufficient information, giving rise to unsubstantiated generalizations about consumers. More information can be obtained, but often at substantial cost.

For example, consumer segments are frequently defined by demographic, behavioral, and/or attitudinal characteristics obtained from consumer panelists participating in a marketing research study conducted by a marketing research entity (e.g., The Nielsen Company (US), LLC). In such examples, the demographic characteristics of the panelists can be collected when consumers enroll as panelists. Further, once consumers become panelists, their purchasing behavior (e.g., what products they buy, in what quantity, at what price, etc.) can be tracked and recorded at relatively little expense. However, obtaining attitudinal and/or psychographic information about consumers is more difficult without incurring significant costs.

As used herein, the “attitudes” of consumers refers to the preferences, sentiments, and/or interests of consumers. While consumer attitudes may be directed towards particular products or types of products, attitudes may also be directed toward specific features, attributes, qualities, and/or characteristics of such products. Thus, in some examples, the attitudes of consumers towards a product may be a composite of their attitudes towards particular features of the product. For example, a consumer may dislike a certain feature of a product but like other aspects of the product for an overall positive attitude. Further, consumer attitudes as described herein are indicative of the behavioral propensities of towards particular products (and/or product features). Thus, consumer attitudes may reflect a likelihood of purchasing a particular product, a likelihood of recommending a product to a friend, a likelihood of giving a positive (or negative) review for a product, etc.

In some examples, consumer attitudes (e.g., the reasons why consumers hold particular views and/or engage in particular behavior) are modeled using some correlation of product characteristics and panelist demographics but such approaches are often overgeneralized and unreliable. In other examples, attitudes are incorporated using surveys and/or focus groups but such approaches are expensive and time consuming to implement. Furthermore, surveys and/or focus groups may be unreliable because they are often based on vague, hypothetical, and/or biased questions. Despite the cost and inherent deficiencies, businesses still implement such techniques to obtain attitudinal data because such data can reveal latent attitudes, non-obvious brand perceptions, and/or gaps in product offerings that can assist businesses in future marketing and product development efforts. Thus, there is a need for methods to obtain attitudinal information from consumers that can be integrated with other panel information (e.g., demographics and purchasing behavior) that provides more reliable feedback and that is obtained with much less time and expense.

Examples disclosed herein fulfill these needs by using the attitudinal information contained in online reviews of the same or similar products purchased by panelist members. Reviews of products (whether goods or services) provide a concrete and direct indication of the attitude of the reviewers towards the reviewed products. That is, online reviewers are not potential purchasers hypothesizing about the best features of a product, as is often the case with survey respondents and members of focus groups. Rather, reviewers are actual purchasers providing their post-purchase opinions based on their actual experience with the products being reviewed. Furthermore, there is no need to conduct costly surveys or focus groups to elicit consumer feedback because it is freely provided by the reviewers. Further still, such reviews are often freely accessible or at a relatively small cost. Additionally, acquiring attitudinal information from online reviews in this manner means that there is no need to seek feedback from the panelists, so that there is less of a burden placed on panelists. That is, unlike other approaches, panelist preferences do not need to be requested or measured by interaction with the panelists.

The examples disclosed herein take advantage of the proliferation of online reviews of products by collecting information contained in such reviews and integrating this information (e.g., using statistical techniques) with purchasing behavior data collected from consumer panelists to match the reviews (and, thus, the attitudes) of reviewers to the panelists. In this manner, the attitudes are imputed to the panelists and can then be extrapolated to larger populations such as particular marketing segments. More particularly, examples disclosed herein statistically decompose the quantitative assessments (e.g., via scores or ratings) of products and/or product features from online reviews provided by many reviewers over time to identify particular sets of reviewers that hold opinions that strongly correlate with the purchasing behavior of different panelists. Thus, in some examples, the reviews of a particular set of reviewers correlated with a particular panelist may be used to predict the attitudes and corresponding purchasing behavior of the panelist. In some examples, the attitudes imputed to the panelists in this manner are then combined with the demographic characteristics and purchasing behaviors of the panelists to then develop and identify marketing segments and/or to predict the attitudes and/or preferences of known marketing segments to which the panelists belong. The purchasing preferences or attitudes determined in the disclosed examples can be used in other marketing analyses such new product design, market sizing, return on investment (ROI) analysis, trends and sales, etc.

The examples disclosed herein may be applied to the products of any industry where there are a sufficient number of online reviews and a sufficiently large group of panelists for which purchasing behavior data has been collected. Online reviews for most types of goods and services, from hotels and restaurants to automobiles and electronics, have been around for a number of years. In more recent years, there has been a significant increase in reviews of consumer packaged goods (CPGs), also known as fast-moving consumer goods (FMCGs). CPGs are relatively low cost items that are purchased on a frequent basis by the average consumer. Examples of CPGs include food and beverages, clothing, and household products. While the examples disclosed herein may be applied to any type of good or service, the frequent purchase of CPGs by consumers allow for large amounts of purchasing data to be collected from panelists, which is important to the robustness of the examples disclosed herein. That is, to have a relatively high level of confidence in the attitudes of consumer panelists imputed from online reviewers depends upon having a large panel having purchased many products and a large base of reviews by many reviewers to statistically correlate together or otherwise match based on statistically determined relationships.

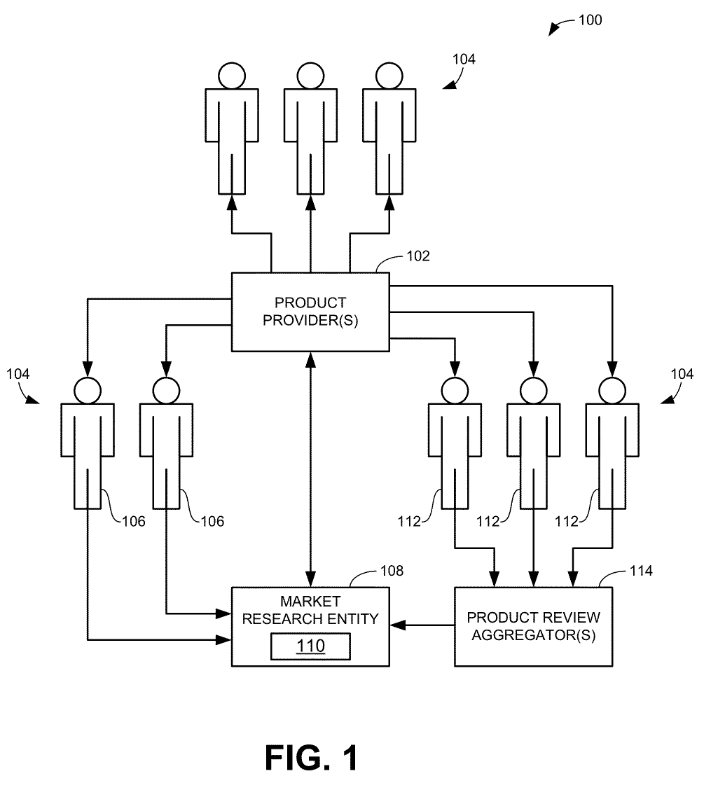

FIG. 1 is a schematic illustration of an example system 100 within which the teachings disclosed herein may be implemented. The example system 100 of FIG. 1 includes one or more product provider(s) 102 that provide products to consumers 104 for purchase. The products may be either goods or services. In some examples, the product provider(s) 102 are manufacturers of goods that are sold to the consumers 104 through a retailer or other intermediary (which also constitutes a product provider 102 as described herein). In other examples, the product provider(s) 102 may directly sell their products to the consumers 104. In some examples, the product provider(s) 102 sell their products via a brick-and-mortar store. Additionally or alternatively, in other examples, the product provider(s) 102 sell their products via the Internet.

In the illustrated example, some of the consumers 104 purchasing products from the product provider(s) 102 are panelists 106 of a market research panel. Consumer panelists 106 are consumers 104 registered on panels maintained by a market research entity 108 to gather market data (e.g., purchasing behavior data) from panel members that can be tied to the demographic characteristic of the panel members. That is, the market research entity 108 enrolls people (e.g., the consumers 104) that consent to being monitored into a panel. During enrollment, the market research entity 108 receives demographic information from the enrolling people (e.g., consumer panelists 106) so that subsequent correlations may be made between the purchasing behavior data associated with those panelists and different demographic markets. People may become panelists 106 in any suitable manner such as, for example, via a telephone interview, by completing an online survey, etc. Additionally or alternatively, people may be contacted and/or enlisted using any desired methodology (e.g., random selection, statistical selection, phone solicitations, Internet advertisements, surveys, advertisements in shopping malls, product packaging, etc.).

In some examples, once a person enrolls as a consumer panelist 106, the market research entity 108 tracks and/or monitors the purchasing behavior of the consumer panelist. In some examples, purchasing behavior data is available for consumers 104 that are not formally enrolled in a particular research panel. Thus, the teachings disclosed herein may be suitably applied to any consumers for which purchasing behavior data is available. However, for purposes of explanation, the teachings disclosed herein are described with respect panelists 106.

As used herein, “purchasing behavior data” refers to panelist-based purchasing information including an identification of the products purchased by the panelists 106 (referred to herein as “panelist purchased products”) over time and relevant information about the products and/or the circumstance of the purchase. For example, purchasing behavior data includes information about the panelist purchased products such as, for example, a universal product code (UPC) for each product, a category of products to which each product belongs, a description of each product (overall and/or of particular characteristics (e.g., size, weight, color, dimensions, etc.)), claims of each product (e.g., “100% all natural,” “clinical proven to lower cholesterol,” etc.), a brand of each product, and features or characteristics of each product. In some examples, the product description, brand, and features may be available in conjunction with the UPC provided by the product manufacturer. Additionally or alternatively, in some examples, description, brand, or feature information may be generated based on other sources to supplement and/or expand upon UPC data. Further, purchasing behavior data includes information about the purchases of each panelist purchased product such as, for example, the price paid for each product, the quantity bought, the frequency with which each product is bought, promotional information associated with each product at the time of purchase, the store from which each product is bought, and the geographic location of the store (or whether bought online).

In some examples, purchasing behavior data is collected through the panelists 106 logging all of their purchases and providing the same to a data processing facility 110 of the market research entity 108 on periodic (e.g., weekly). In some examples, the market research entity 108 may provide a scanner to the panelists 106 to scan the barcode of every product they purchase. In such examples, the scanner may generate a report that is transmitted to the data processing facility 110 on a particular schedule and/or as needed. In some examples, the scanner functionality may be provided via an application implemented on a smartphone or other computing device of the panelists 106. Further, any other suitable method to collect the purchasing behavior data from the panelists 106 may additionally or alternatively be implemented.

In some examples, the market research entity 108 analyzes the purchasing behavior data to identify the products purchased by each panelist 106 (e.g., based on the UPCs for each product). Further, in some examples, the market research entity 108 analyzes the purchasing behavior data to identify particular features of the products purchased. In some examples, the features are identified by accessing and parsing information associated with the UPCs for each product. In some examples, the market research entity 108 may designate additional and/or different features for each product. In some examples, the features may be designated by the product provider(s) 102 (e.g., a manufacturer of the product) and/or a third party entity. In some examples, the market research entity 108 maintains a feature database that stores all of the features identified for each product for subsequent analysis as described more fully below.

In the illustrated example of FIG. 1, some of the consumers 104 purchasing products from the product provider(s) 102 are reviewers 112. A reviewer 112 is a consumer 104 that provides an online review of a purchased product to one or more product review aggregator(s) 114. Often, the reviewers 112 are self-selecting in that they volunteer their reviews without such feedback being specifically solicited. The product review aggregator(s) 114 of the illustrated example collect product reviews from reviewers 112 and post them online. In some examples, the product review aggregator(s) 114 are associated with or the same as the product provider(s). That is, a reviewer 112 may purchase a product from a particular product provider 102 and then provide a review of the product to the same product provider 102 (as a product review aggregator 114) for display on a website maintained by the product provider 102. In other examples, the product review aggregator(s) 114 are separate entities from the product provider(s) 102 that maintain websites primarily dedicated to the aggregation of product reviews (e.g., Consumr.com, ConsumerSearch.com, ConsumerReports.org, etc.).

Typically, online product reviews include a quantitative evaluation or assessment of a product in the form of a ranking, score, or rating of the reviewed product. In some examples, the rating of a product in a review may be binary (e.g., positive/negative, good/bad, like/dislike, thumbs up/thumbs down, etc.). In other examples, the rating of a product may be on a scale (e.g., 1 to 4, 1 to 5, 0 to 10, etc.). In either case, such ratings may be numerically quantified (if not already provided as a number) for statistical analysis purposes.

Additionally or alternatively, some product reviews include ratings of specific features, attributes, qualities, and/or characteristics of the reviewed product. For example, some reviews may provide ratings on the ease of use, the value for the price, or the durability of a product. Further, in some examples, reviews may include comments entered by the reviewers 112 indicating specific features, attributes, and/or characteristics the reviewers 112 perceive as informing their opinions. Such reviewer-identified features may be positive features (that the reviewer likes) or negative features (that the reviewer dislikes). In some examples, the positive and negative features identified by reviewers are provided in separate sections of a review (e.g., a first section listing the pros identified by a reviewer and a separate section listing the cons identified by the reviewer). In other examples, the positive and/or negative features may be identified based on the context of the comments provided. In some examples, a rating of specifically identified features is determined based on a textual analysis of the reviews. For example, reviews that include comments typed in all capital letters, use exclamation points, use superlatives, etc., may indicate the enthusiasm (or disdain depending on the context) a reviewer has for a product indicating a relatively higher (or lower) rating for the particular feature being commented upon. In some examples, the features of a product are assigned the same rating as that which is assigned to the product itself. In other examples, individual feature ratings may be different than a corresponding product rating.

Additionally, reviews typically include an identification of the reviewer 112. In some examples, the identification may be the real name of the reviewer 112, while in other examples the identification may be a made up moniker or alias. In some examples, for a consumer 104 to write a review (and become a reviewer 112), the consumer 104 must register with the product review aggregator(s) 114. Thus, in such examples, the identifier for the reviewer 112 is typically consistent across multiple reviews from the same reviewer. In some examples, either in conjunction with registering as a reviewer or in conjunction with providing a particular review, reviewers 112 may provide additional information (e.g., demographic information, location information, etc.) about themselves.

In the illustrated example, the market research entity 108 accesses the websites maintained by the product review aggregator(s) 114 to retrieve product review data based on the online reviews. As used herein, “product review data” refers to information obtained from online reviews including an identification of each reviewer 112 (e.g., the name or moniker under which the reviewer 112 posts reviews), other available information about the reviewer 112 (e.g., demographic characteristics, geographic location, potential biases in opinions (e.g., a paid reviewer), etc.), an identification of the products each reviewer 112 have reviewed, the quantitative evaluation (e.g., rating) of each product and/or product feature assigned by each reviewer 112, textual comments and/or other information provided by reviewers 112 as part of their reviews, and information to validate the review and/or the reviewer (e.g., feedback from other consumers on the helpfulness of a review, etc.). In some examples, the product review data is collected using a web crawler that scans one or more websites maintained by the product review aggregator(s) 114. In other examples, the product review aggregator(s) 114 may provide the product review data (or portions thereof not available using a web crawler) to the market research entity 108 based on a statistically established relationship between them.

In the illustrated example, there will be many different products purchased by the panelists 106. Likewise, there will be many different products reviewed by the reviewers 112. In some examples, the products purchased by the panelists 106 may correspond to the products reviewed by the reviewers 112 (e.g., the products are the same as or at least similar). In some examples, there may be products purchased by panelists 106 that have not been reviewed by any reviewers 112 and/or there may be products that have been reviewed by reviewers 112 but not purchased by any panelists 106. For convenience of explanation, products purchased by the panelists 106 are referred to herein as panelist purchased products and products reviewed by the reviewers 112 are referred to herein as reviewed products regardless of whether these correspond to the same products or different products.

In the illustrated example, the number of panelists 106 and reviewers 112 and the corresponding number of products purchased and reviewed are sufficiently large to enable big data analytic techniques to match (e.g., correlate) the reviewers 112 to the panelists 106. As a result, the attitudes or sentiments of the reviewers 112 (indicated by their reviews) can be imputed to the panelists 106 with certain levels of statistical confidence. That is, in some examples, as disclosed more fully below, the data processing facility 110 performs data integration on the purchasing behavior data gathered from the panelists 106 and the product review data gathered from the product review aggregator(s) 114 to identify a set of reviewers 112 that have provided reviews that statistically align (e.g., are relatively strongly correlated) or are otherwise closely related to the purchases made by a particular panelist 106. In some examples, the data processing facility 110 assigns different weights to different ones of the reviewers 112 among the set of reviewers identified for a particular panelist 106. In some examples, such weights are based on the strength of relationship between the different ones of the reviewers 112 and the panelist's purchasing behavior determined based on a mathematical or statistical analysis of the relationships. Each panelist 106 is unique (as is each reviewer 112) such that the set of reviewers 112 statistically correlated or otherwise matched to each panelist 106 (and/or the reviewers' associated weights) will likely be different.

With a set of reviewers 112 identified for each panelist 106, the attitudes underlying the purchasing behavior of the panelist 106 can be predicted based on the reviews of the reviewers 112. Obviously, if a panelist 106 has repeatedly purchased a product, it is probable that the panelist 106 likes the product without having to consider the reviews of the product by reviewers 112. However, in some examples, the reviews of the set of reviewers 112 can provide an indication of why the panelist 106 likes the product (and/or if there are other factors that play a role in the panelist's purchasing behavior and/or underlying attitudes). In particular, in some examples, the data processing facility 110 analyzes the products purchased by the panelists 106 and reviewed by the reviewers 112 based on the features associated with such products. In some examples, the actual reason for the opinions held by particular reviewers 112 towards certain products are explicitly identified by the reviewers identifying the features of the products they like or dislike. In some examples, these reasons (attitudes towards particular features) for liking or disliking a particular product identified by the reviewers 112 are imputed to the panelists 106. In this manner, the attitudes of the panelists 106 can be determined without eliciting their feedback on their purchases and without having to conduct any surveys or focus groups.

In addition to predicting the attitudes of panelists 106 to the products they purchase by imputing the attitudes conveyed in the reviews of the set of reviewers 112 representative of each panelist 106, in some examples, the attitudes of the panelists 106 can be predicted with respect to products they have not purchased. For example, the data processing facility 110 may use reviews by the set of reviewers 112 of products the panelist 106 has not previously purchased to predict the probable attitude of the panelist 106 towards such products. Furthermore, in some examples, the reviews by the reviewers 112 are used to predict the attitudes of the panelists 106 with respect to products that neither the panelists 106 have purchased nor the reviewers 112 have reviewed. Such predictions are based on the ratings of features associated with products that the reviewers 112 have reviewed. For example, if the reviews from a set of reviewers 112 indicate an affinity for snack products with the features of being salty, crunchy, and air-popped and a new product exhibits the same features, the attitude of the panelist 106 represented by the set of reviewers 112 may be predicted as positive towards the new product. In a similar manner, the imputed attitudes of panelists 106 can be used in developing new products. Additionally or alternatively, in some examples, the data processing facility 110 analyzes the calculated attitudes for the panelists 106 in conjunction with the demographics of the panelists 106 and their purchasing behavior to extrapolate the predictions to a more general population and/or market segment.

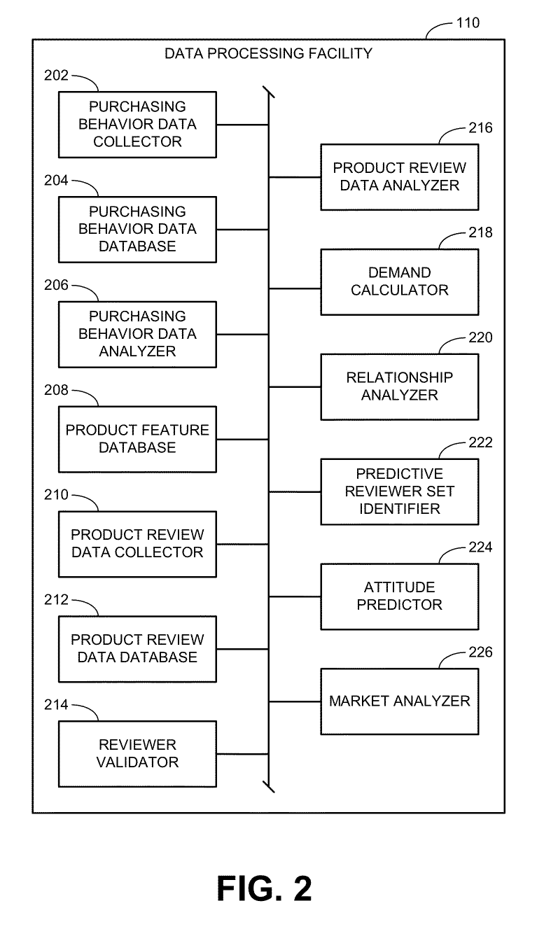

FIG. 2 is a block diagram of an example implementation of the example data processing facility 110 of FIG. 1. The example data processing facility 110 includes an example purchasing behavior data collector 202, an example purchasing behavior data database 204, an example purchasing behavior data analyzer 206, an example product feature database 208, an example product review data collector 210, an example product review data database 212, an example reviewer validator 214, an example product review data analyzer 216, an example demand calculator 218, an example relationship analyzer 220, an example predictive reviewer set identifier 222, an example attitude predictor 224, and an example market analyzer 226.

In the illustrated example of FIG. 2, the data processing facility 110 is provided with the example purchasing behavior data collector 202 to collect purchasing behavior data from consumer panelists 106. As described above, in some examples, the market research entity 108 may provide scanners to the consumer panelists 106 to scan each UPC barcode of each product they purchase. In some examples, the scanning functionality may be provided via an application on a smartphone or other computing device of the panelist. Additionally, in some examples, the panelists 106 may enter other relevant information (e.g., location of purchases, promotional details, etc.) into the scanner (or other computing device). The scanned information as well as any additional panelist-provided information constitutes the purchasing behavior data that is subsequently transmitted to the data processing facility 110 and received by the purchasing behavior data collector 202. In other examples, the panelists 106 may log all relevant information (e.g., entered onto a computer without a scanner) for subsequent transmission to the purchasing behavior data collector 202. Communications between the scanner (or other suitable computing device) and the example purchasing behavior data collector 202 may be accomplished through any means such as, for example, via a wireless telephone network, over the Internet, etc. In the illustrated example, once the purchasing behavior data is received from a panelist 106 it is stored in the purchasing behavior data database 204 along with purchasing behavior data obtained from other panelists 106.

The example data processing facility of FIG. 2 is provided with the example purchasing behavior data analyzer 206 to analyze the collected purchasing behavior data. In some examples, the purchasing behavior data analyzer 206 analyzes the data by identifying the products purchased by each panelist 106. In some examples, the panelist purchased products are identified based on the UPC included in the purchasing behavior data. In some examples, the purchasing behavior data analyzer 206 further analyzes the purchasing behavior data to determine and/or identify specific features associated with the panelist purchased products. In some examples, the features are derived from information associated with the UPC and/or other product description information (e.g., as provided from a manufacturer of the product and/or a third party). In some examples, the features are directly identified by the product provider 102 and provided to the market research entity 108 for consideration in a particular market research study. In some examples, the features are derived from information obtained from other sources.

Regardless of the source of information from which the features of different products are acquired, in some examples, the features are stored in the product feature database 208. In this manner, as additional purchasing behavior data is received, the purchasing behavior data analyzer 206 may perform a lookup of the identified products to determine the corresponding features rather than performing a direct analysis of the purchasing behavior data.

Additionally, in some examples, the purchasing behavior data analyzer 206 analyzes the purchasing behavior data to determine purchasing behavior metrics associated with the panelist purchased products. In some examples, the purchasing behavior metrics include metrics associated with the products and/or associated with the circumstances of the purchases. For example, the purchasing behavior data analyzer 206 may determine a quantity of each product purchased (e.g., at a single time and/or over a set period of time). In some examples, the quantity may be the raw number of products purchased, while in other examples, the quantity may be calculated relative to a number of household members in the panelist's household. The example purchasing behavior data analyzer 206 may determine a frequency each product is purchased over a set period of time (e.g., two week, one month, three months, one year, etc.). As with the quantity, in some examples, the frequency may be a raw frequency, a standardized frequency, and/or frequency per household member. The example purchasing behavior data analyzer 206 may determine a price paid for each product purchased. The example purchasing behavior data analyzer 206 may determine promotional information associated with each product purchased. For example, whether the product was on sale (e.g., sold at a reduced price) or sold as part of a bundle (e.g., buy two get one free), whether the product was mentioned in an advertisement, whether the product was part of a promotional display, etc. The example purchasing behavior data analyzer 206 may determine a brand associated with each product purchased. The example purchasing behavior data analyzer 206 may determine a location where each product was purchased including the identification (e.g., name) of the store, the geographic location of the store, and/or whether the purchase was made in a brick-and-mortar store or online.

In the illustrated example of FIG. 2, the data processing facility 110 is provided with the example product review data collector 210 to collect and/or obtain review data. As described above, product review data includes information associated with online reviews of products including the identification of the product, the identification of the reviewer, the quantitative evaluation of the product and/or product features (e.g., ratings assigned by the reviewer), any textual comments provided by the reviewer, and/or any other information available about the reviewer and/or the review. In some examples, the product review data collector 210 is implemented using a web crawler that captures the product review data directly from websites maintained by the product review aggregator(s) 114. In some examples, the product review aggregator(s) 114 may provide the product review data to the product review data collector 210. In either case, as the product review data is obtained, the product review data collector 210 stores it in the product review data database 212 for subsequent analysis.

In some examples, the data processing facility 110 is provided with the reviewer validator 214 to validate reviewers 112 associated with the collected product review data and/or filter out reviews of reviewers 112 that cannot be validated. To validate a reviewer, as described herein, is to confirm that the reviewer provides reliable and meaningful reviews. Various factors may play a role in validating a reviewer. In some examples, the reviewer validator 214 only validates reviewers that have provided at least a threshold number of reviews (e.g., ten or more) because the attitudes of reviewers 112 that have only provided one or two reviews cannot be accurately assessed. As such, in some examples, the reviewer validator 214 filters out the reviews from reviewers 112 with less than the threshold number of reviews associated with themselves. In some examples, the reviewer validator 214 filters out reviewers 112 that provide little or no variance in their reviews. That is, reviewers 112 who constantly give products 5/5 stars or, conversely, constantly give products 1/5 stars cannot be relied upon to differentiate between different products and/or their features and, therefore, may be excluded from further analysis. In some examples, the reviewer validator 214 analyzes the product review data to identify potential biases in the reviewer 112 such as, for example, whether the reviewer is paid to give positive reviews. In some examples, if a biased reviewer is detected the corresponding reviews of the reviewer are filtered out.

In some examples, the reviewer validator 214 validates reviewers based on validation information provided by the product review aggregator(s) 114 as part of the collected product review data. Frequently, in addition to aggregating reviews, product review aggregator(s) 114 make efforts to validate the reviews posted on their websites. In some examples, this is accomplished by the product review aggregator(s) 114 requiring registration of reviewers. In some examples, this is accomplished by the product review aggregator(s) 114 collecting feedback from other consumers indicating whether particular reviews are helpful. Some product review aggregator(s) 114 provide rankings of top reviewers (e.g., Amazon's Top Customer Reviewers) from which validated reviewers can be identified. In some examples, such information is collected as part of the product review data and analyzed by the reviewer validator 214 to validate reviewers so that their reviews can be confidently relied upon when implementing the teachings disclosed herein.

In the illustrated example of FIG. 2, the data processing facility 110 is provided with the example product review data analyzer 216 to analyze the collected product review data. In some examples, the product review data analyzer 216 analyzes the data by identifying the products reviewed by each reviewer 112. In some examples, the reviewed products are identified by a name or description included with the review. In some examples, the reviewed products are identified when the product review data collector 210 initially collects the product review data. For example, frequently a product review aggregator 114 posts all reviews for a particular product at one time such that all of the reviews are collected at the same time and each is associated with the particular product when the data is stored in the product review data database 212. In some examples, the reviewed products are identified based on UPC information included with the review and/or provided on the website where the review is posted.

In some examples, the product review data analyzer 216 further analyzes the product review data to determine or identify specific features associated with the panelist purchased products. In some examples, the features of reviewed products are derived in the same manner as the features identified for the panelist purchased products. That is, the product review data analyzer 216 may access UPC information, product descriptions, and/or other information associated with each product. In some examples, the features may be looked up in the product feature database 208. In some examples, the product review data analyzer 216 identifies the features of each product based on the content of the associated reviews. In some such examples, the features are specified by the product review aggregator(s) 114, in which case, the reviewers 116 give an opinion (e.g., a ranking) of such specified features. In other examples, features are identified based on textual comments provided by the reviewers 116.

Features identified by reviewers may vary widely as each reviewer is unique. Further, reviewer comments may identify features vastly different from what is contemplated by the manufacturer and/or is included in the product description. For example, features associated with muffins that a manufacturer may provide and/or would be identified based on UPC information and/or other product description information might include fresh, whole wheat, gluten free, low fat, etc. While a reviewer may identify with one or more of these features, a reviewer 112 may also provide other less traditional features that are important to the reviewer. For example, a reviewer might give a particular muffin product a positive review with the following comment: “These muffins are super soft and I especially love eating them with orange juice.” From this reviewer's comment the product review data analyzer 216 may identify the features of (1) super soft, and (2) good with orange juice, as being important to the particular reviewer. Thus, in some examples, the product review data analyzer 216 parses the texts or comments in the reviews to identify any aspect or concept the reviewers 112 identify as relevant to the reviewed product and includes that as an additional feature of the product. That is, as used herein, a “feature” of a product refers to any characteristic, attribute, or concept associated with a product that may inform a consumer's attitudes or sentiments towards the product. In some examples, whether a concept is associated with a product is based on the perceptions of reviewers specifying the concept in their reviews. In some examples, such features are identified based on word associations. That is, the features directly correspond to the terms appearing in the reviews (e.g., “super soft” and “orange juice”). In other examples, the features may be identified based on more complex textual analysis. For example, the phrase “orange juice” may be identified as corresponding with the concept of “fruit drinks.”

With many different reviewers 112 reviewing the same product, the product review data analyzer 216 is likely to identify many different features (based on the perceptions of the reviewers) for the product. In some examples, similar features will recur in reviews of other products. For example, in addition to identifying muffins as super soft in the above example, the same reviewer (and/or another reviewer) may identify a particular loaf of bread as “very soft” and a particular brand of tortilla shells as “extra soft.” In some such examples, the product review data analyzer 216 identifies each of these reviewer-specified features as corresponding to the same general feature. As such, in some examples, the product review data analyzer 216 effectively identifies each of these products as having the same feature. Thus, in some examples, product features are identified based on reviews across multiple different products.

In some examples, linguistically similar features identified by reviewers may have no relation. For example, a reviewer may also describe a brand of toilet paper as super soft. In some such examples, the product review data analyzer 216 may identify the feature of “super soft” for toilet paper but keep it separate from the “super soft” feature identified for muffins because of the difference between products. In other examples, the product review data analyzer 216 may not distinguish between products.

In some examples, in parsing review comment language, the product review data analyzer 216 may interpret the context of words to exclude terms that are used in the review but not indicative of features associated with the product. For example, a review of a cleaning product that reminds a reviewer of the smell of cut grass might link “grass” as a feature to the cleaning product identified by the reviewer. By contrast, the term “grass” is of no significance to a review of a food product that a reviewer happens to describe as being eaten while sitting on grass at a picnic. Thus, in some examples, the product review data analyzer 216 analyzes the reviewer comments to identify any features specified by the reviewer while limiting the impact of language that is irrelevant to the reviewers' sentiments toward the products being reviewed. In the illustrated example, as the product review data analyzer 216 identifies the features associated with each reviewed product, the features are added to the product review database 212.

Additionally, in some examples, the product review data analyzer 216 analyzes the product review data to determine quantitative evaluations given by the reviewers 112 to the products and/or identified features. In some examples, the quantitative evaluations are based on a rating or score designated by each reviewer 112. In some examples, there may be a single rating applied to each product. In some such examples, the overall rating for the product may be applied to each of the features of the product. In other examples, the rating is applied only to the features specifically identified by the corresponding reviewer 112. In some examples, a review may include multiple ratings corresponding to different features of the reviewed product. In some examples, the product review data analyzer 216 determines the quantitative evaluations based on an analysis of the textual comments provided by the reviewers 112. For example, comments that use all capital letters, exclamation points, superlatives, etc., may indicate the enthusiasm (or disdain depending on the context) a reviewer has for a product indicating a relatively higher (or lower) rating for the particular product and/or feature being commented upon.

In the illustrated example of FIG. 2, the data processing facility 110 is provided with the example demand calculator 218 to calculate a relative demand for each product and/or product feature purchased by each panelist 106 and/or reviewed by each reviewer 112. In some examples, the demand calculator 218 statistically compares (e.g., via a regression analysis) the purchasing behavior metrics (e.g., price, quantity, etc.) of each panelist 106 relative to all other panelists 106 for all panelist purchased products to determine the relative demand of each panelist 106 for each product. For example, a particular panelist that buys a significantly larger quantity of a particular product (standardized for price variation and/or other factors) than other panelists likely exhibits a much higher demand for that product. Thus, in such examples, the demand calculator 218 will assign a value (referred to herein as a demand index) to the particular panelist with respect to the particular product that is much higher than the value assigned to other panelists for the same product.

Additionally or alternatively, in some examples, the demand calculator 218 calculates a demand index that is assigned to each panelist 106 for each feature of the panelist purchased products. As described above, many features will be common to multiple products such that the demand index for each panelist 106 will be based on the total number of products the panelist purchased having the identified feature (whether this corresponds to one product or many different products). Thus, a panelist 106 that buys a lot of “soft” muffins may have a relatively high demand index for the feature “soft” when compared against other panelists 106, but not as high as the demand index assigned to another panelist 106 that buys a lot of “soft” muffins, “soft” bread, “soft” tortilla shells, etc. In some examples, the feature demand analysis of the panelists 106 is performed with respect to the features identified independent of the reviewers 112 (e.g., based solely on the features identified from the UPC and/or description information associated with each product). In other examples, the features identified through an analysis of the review data are merged with the other identified features and demand indices are calculated for such features as well as the features based on UPC or other product description information.

Additionally, in some examples, the demand calculator 218 calculates and assigns a demand index to each reviewer 112 for each product and/or product feature in a similar manner as described above. However, whereas the demand indices for each feature assigned to each consumer panelist 106 are based on the quantity of products purchased that have the particular feature, the demand indices assigned to each reviewer 112 are based on the rating each reviewer assigns to each feature as well as the quantity of products reviewed that have the particular feature and/or whether the feature was specifically mentioned by the reviewer.

The example data processing facility 110 of FIG. 2 is provided with the relationship analyzer 220 to match or identify a relationship between the reviewers 112 and the panelists 106. In some examples, such relationships are determined based on statistical correlations. In some examples, the relationship analyzer 220 determines a strength of relationship (e.g., a strength of correlation) between each reviewer 112 and each panelist 106 based on the calculated demand indices for each. In other words, in some examples, the strength of relationship is based on how closely the attitudes of the reviewers 112 (indicated by their ratings of products and/or product features) reflect the purchasing behavior of the panelists 106. Underlying this assessment is the assumption that people buy what they like and do not buy the things they do not like. Thus, if a panelist 106 frequently buys a particular product (e.g., has a relatively high demand index for that product), the assumption is that the panelist 106 likes that product. As such, a reviewer 112 that also likes that product would be positively related to the panelist 106 (at least with respect to that product). By analyzing the many products purchased by the panelists 106 against the many products reviewed by the reviewers 112, the strength of relationship between each of the reviewers 112 and the panelists 106 can be calculated.

In some examples, the relationships between reviewers 112 and panelists 106 are determined on a product by product basis. That is, the products a reviewer 112 rates highly in a review are correlated to the products frequently purchased by the panelists 106. While such relationships may serve as a model that provides some predictive power into the purchasing behavior of the panelists 106, there are so many reason people choose to buy or do not buy things that a product level assessment is of relatively little value. Accordingly, in some examples, the relationship analyzer 220 calculates relationships between panelists 106 and reviewers 112 based on product features. Such relationships can provide much better predictions of purchasing behavior (and the underlying attitudes of the purchasers) because they get at the reasons why a consumer chooses to buy one product over another or engage in other behavior associated with a product (e.g., give a positive review for the product).

Each panelist 106 and each reviewer 112 are unique. As such, no single reviewer 112 is likely to perfectly correlate with any panelist 106. Indeed, it is unlikely that a single reviewer 112 will have reviewed more than a fraction of the products purchased by a particular panelist 106. Accordingly, in the illustrated example of FIG. 2, the data processing facility 110 is provided with a predictive reviewer set identifier 222 to identify a set or group of reviewers 112 that collectively provide a statistically defined (e.g., optimized) composite reviewer persona reflective of a particular panelist 106. That is, while any one of the set of reviewers 112 may be somewhat correlated to the panelist 106 for certain products and/or features, in some examples, the combined group of reviewers 112 identified by the predictive reviewer set identifier 222 create an as complete model as possible (based on the available data and the analytical (e.g., statistical) techniques employed) to predict the purchasing behavior and attitudes of the panelist 106. In some examples, the set of reviewers 112 are identified based on the strength of relationship between each such reviewer 112 and the corresponding panelist 106. For instance, in some examples, the set of reviewers 112 corresponds to all reviewers having a strength of relationship with respect to a particular panelist 106 that exceeds a certain threshold.

In some examples, the predictive reviewer set identifier 222 assigns different weights to each of the reviewers 112 within the identified set of reviewers. For example, the reviewers 112 with stronger relationships may be given a greater weight than other reviewers 112 within the set identified for a particular panelist 106.

In some examples, rather than analyzing the strengths of relationships for each reviewer 112 individually before identifying the composite set of reviewers representative of a particular panelist 106, the determination of the relationships and the set of reviewers are accomplished simultaneously. That is, in some examples, the relationship analyzer 220 and the predictive reviewer set identifier 222 work in tandem to identify a statistically defined (e.g., optimized) grouping of reviewers 112 that collectively have reviews that model the purchasing behavior of a particular panelist 106. In some such examples, the reviewers 112 identified and/or the weights given to each reviewer may not correspond to the most strongly correlated reviewers when analyzed individually.

In some examples, the predictive reviewer set identifier 222 identifies the set of reviewers 112 based on an overall assessment of the purchasing behavior of a particular panelist 106. In other examples, the set of reviewers 112 may be identified based on particular products, product categories, and/or product features of interest in a particular research study. Thus, the particular set of reviewers 112 identified by the predictive reviewer set identifier 222 may differ depending upon the nature of the analysis being performed.

In the illustrated example of FIG. 2, the data processing facility 110 is provided with the example attitude predictor 224 to predict the attitude of the panelists 106 towards certain products and/or product features. In particular, the attitude predictor 224 analyzes the reviews of the set of reviewers 112 identified by the predictive reviewer set identifier 222 to determine the reviewers attitudes and then impute those attitudes onto the panelist 106. In some examples, the attitude predictor 224 predicts the attitude of the panelists 106 towards products they have previously purchased. In such examples, it is already apparent that the panelists 106 probably have positive views towards the products or they would not keep buying them. However, by imputing the attitudes of the set of reviewers 112 to the panelist 106, the attitude predictor 224 can predict the preferences and/or sentiment (i.e., attitude) of the panelist 106 that may explain why the panelist 106 makes such purchases (e.g., preferences towards the features or qualities of the product highly rated by the set of reviewers).

In some examples, the attitude predictor 224 predicts the attitudes of panelists 106 towards products the panelists 106 have not previously purchased. In some such examples, the products may have been reviewed (and, thus, purchased) by the reviewers 112. In some such examples, the attitude predictor 224 may predict a panelist 106 will have a positive attitude towards the product based on positive reviews from the reviewers 112 that are identified as associated with the panelist 106. However, as described above, identifying associations based on products themselves can be relatively unreliable. Accordingly, in some examples, the attitude predictor 224 may predict that a panelist 106 will have a positive attitude towards a product never previously purchased based on the features of the product identified and highly rated by the set of reviewers 112.

A similar approach may be implemented to predict the attitude of a panelist 106 towards a product that neither the panelist 106 nor the reviewers 112 have purchased (e.g., a new product that is still in development). In some such examples, the attitude predictor 224 predicts the attitude of the panelist 106 based solely on the features of the product identified by product description information because other features identified based on reviewer comments are not available. In other examples, the attitude predictor 224 may predict the attitude of the panelist 106 towards such a product based on the reviews of the set of reviewers 112 for similar products (e.g., competing products, products in the same product category, products having one or more features in common, etc.). In some examples, the attitude predictor 224 predicts the attitude of the panelist 106 directly based on the features identified by the set of reviewers 112 for the purchased products and/or similar products. Additionally or alternatively, the attitude predictor 224 may predict the attitude of the panelist 106 indirectly based on the features identified by the set of reviewers 112 based on a statistical analysis (e.g., factor analysis) of the identified features or comments provided by the set of reviewers 112.

Although the attitude imputed to a particular panelist 106 may include the direction of the panelist's response to a product (e.g., positive or negative), in some examples, the attitude predictor 224 also predicts the nature or intensity of such a response. For examples, the attitude predictor 224 may predict whether a panelist is likely to be enthusiastic about a product, whether the panelist is likely to recommend the product to others, and so forth. Further, as described above, the attitudes of a panelist 106 determined by the attitude predictor 224 also include an indication of the reasons (or features and/or qualities associated with the products) giving rise to such attitudes.

In the illustrated example of FIG. 2, the data processing facility 110 is provided with the example market analyzer 226 to extrapolate predictions of the attitudes of the panelists 106 to broader populations for marketing analysis purposes. For example, if the panelists 106 are identified as corresponding to a known marketing segment, the market analyzer 226 may predict the attitudes of the particular segment based on the imputed attitude of the panelists 106. Additionally or alternatively, in some examples, the market analyzer 226 defines and/or identifies market segments based on the imputed attitudes of the panelists 106 along with other data known about the panelists (e.g., demographic data and purchasing behavior data). For example, the market analyzer 226 may begin with a particular target product and/or a set of target features of the product and then identify the set of panelists 106 that would positively respond to such products and/or product features. In some such examples, the market analyzer 226 may then identify the associated segment defined by the set of panelists 106. In other examples, the market analyzer 226 may analyze a particular group of panelists 106 associated with a certain segment of interest and identify the products and/or product features to which the segment would respond positively based on positive attitudes exhibited by the panelists 106.

While an example manner of implementing the data processing facility 110 of FIG. 1 is illustrated in FIG. 2, one or more of the elements, processes and/or devices illustrated in FIG. 2 may be combined, divided, re-arranged, omitted, eliminated and/or implemented in any other way. Further, the example purchasing behavior data collector 202, the example purchasing behavior data database 204, the example purchasing behavior data analyzer 206, the example product feature database 208, the example product review data collector 210, the example product review data database 212, the example reviewer validator 214, the example product review data analyzer 216, the example demand calculator 218, the example relationship analyzer 220, the example predictive reviewer set identifier 222, the example attitude predictor 224, the example market analyzer 226 and/or, more generally, the example data processing facility 110 of FIG. 2 may be implemented by hardware, software, firmware and/or any combination of hardware, software and/or firmware. Thus, for example, any of the example purchasing behavior data collector 202, the example purchasing behavior data database 204, the example purchasing behavior data analyzer 206, the example product feature database 208, the example product review data collector 210, the example product review data database 212, the example reviewer validator 214, the example product review data analyzer 216, the example demand calculator 218, the example relationship analyzer 220, the example predictive reviewer set identifier 222, the example attitude predictor 224, the example market analyzer 226 and/or, more generally, the example data processing facility 110 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example purchasing behavior data collector 202, the example purchasing behavior data database 204, the example purchasing behavior data analyzer 206, the example product feature database 208, the example product review data collector 210, the example product review data database 212, the example reviewer validator 214, the example product review data analyzer 216, the example demand calculator 218, the example relationship analyzer 220, the example predictive reviewer set identifier 222, the example attitude predictor 224, and/or the example market analyzer 226 is/are hereby expressly defined to include a tangible computer readable storage device or storage disk such as a memory, a digital versatile disk (DVD), a compact disk (CD), a Blu-ray disk, etc. storing the software and/or firmware. Further still, the example data processing facility 110 of FIG. 1 may include one or more elements, processes and/or devices in addition to, or instead of, those illustrated in FIG. 2, and/or may include more than one of any or all of the illustrated elements, processes and devices.

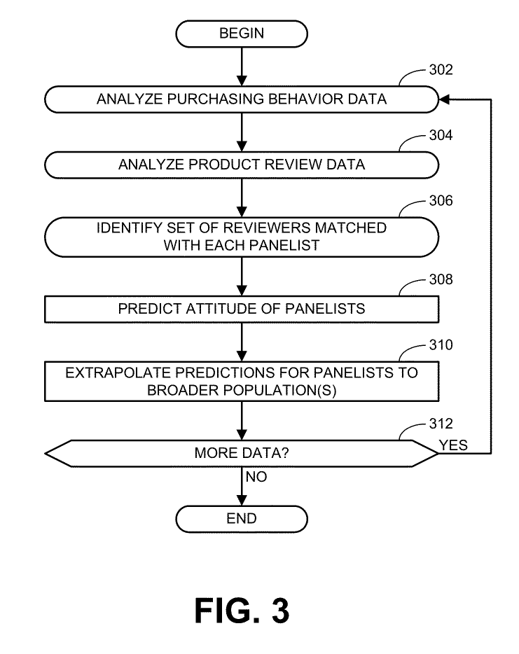

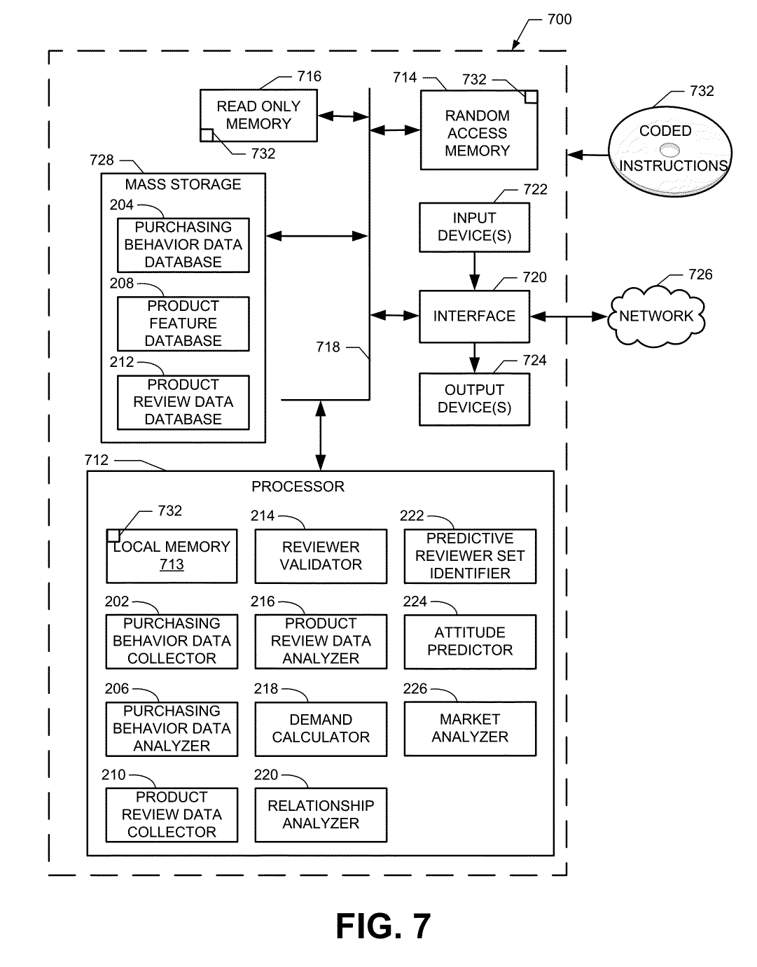

Flowcharts representative of example machine readable instructions for implementing the data processing facility 110 of FIG. 2 are shown in FIGS. 3-6. In this example, the machine readable instructions comprise a program for execution by a processor such as the processor 712 shown in the example processor platform 700 discussed below in connection with FIG. 7. The program may be embodied in software stored on a tangible computer readable storage medium such as a CD-ROM, a floppy disk, a hard drive, a digital versatile disk (DVD), a Blu-ray disk, or a memory associated with the processor 712, but the entire program and/or parts thereof could alternatively be executed by a device other than the processor 712 and/or embodied in firmware or dedicated hardware. Further, although the example program is described with reference to the flowcharts illustrated in FIGS. 3-6, many other methods of implementing the example data processing facility 110 may alternatively be used. For example, the order of execution of the blocks may be changed, and/or some of the blocks described may be changed, eliminated, or combined.

As mentioned above, the example processes of FIGS. 3-6 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 3-6 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

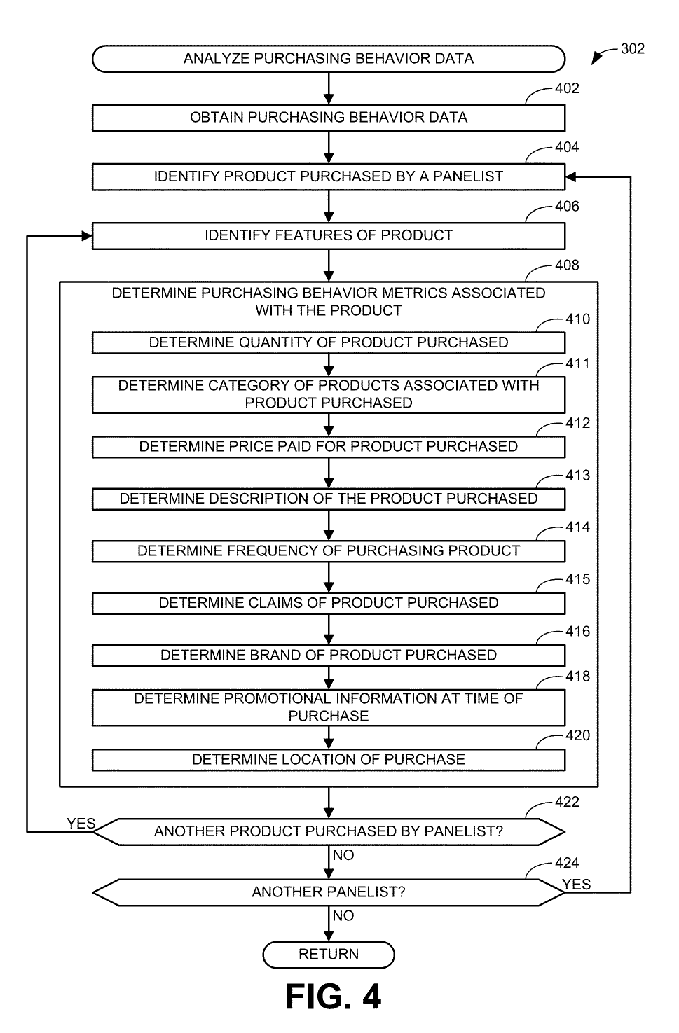

Turning in detail to the figures, FIG. 3 is a flowchart 300 illustrating example machine readable instructions that may be executed to implement the data processing facility 110 of FIGS. 1 and/or 2. The example program of FIG. 3 begins at block 302 where the example purchasing behavior data analyzer 206 analyzes purchasing behavior data. Greater detail regarding the implementation of block 302 is described in connection with the flowchart of FIG. 4.

The example program of FIG. 4 begins at block 402 where the example purchasing behavior data collector 202 obtains purchasing behavior data. In some examples, the purchasing behavior data is obtained from consumer panelists 106 and stored in the purchasing behavior data database 204. At block 404, the example purchasing behavior data analyzer 206 identifies a product purchased by a panelist. At block 406, the example purchasing behavior data analyzer 206 identifies features of the product. In some examples, the features are identified based upon an analysis of UPC and/or other product description information. In some examples, the features are identified based on a look up of the identified product in the product feature database 208 in which the features previously identified have been stored.

At block 408, the example purchasing behavior data analyzer 206 determines purchasing behavior metrics associated with the product. In some examples, determining purchasing behavior metrics includes determining a quantity of the product purchased (block 410), determining a category of products associated with the product purchased (block 411), determining a price paid for the product purchased (block 412), determining a description of the product purchased (block 413), determining a frequency of the purchasing the product (block 414), determining claims of the product purchased (e.g., “No preservatives added,” “100% whole grain,” etc.) (block 415), determining a brand of the product purchased (block 416), determining promotional information at the time of purchase (block 418), and determining a location of the purchase (block 420).

At block 422, the example purchasing behavior data analyzer 206 determines whether there is another product purchased by the panelist. If so, control returns to block 406. If the example purchasing behavior data analyzer 206 determines that there are no more products purchased by the panelist to analyze, control advance to block 424. At block 424, the example purchasing behavior data analyzer 206 determines whether there is another panelist to analyze. If so, control returns to block 404. Otherwise, the example program of FIG. 4 ends and returns to the program of FIG. 3.

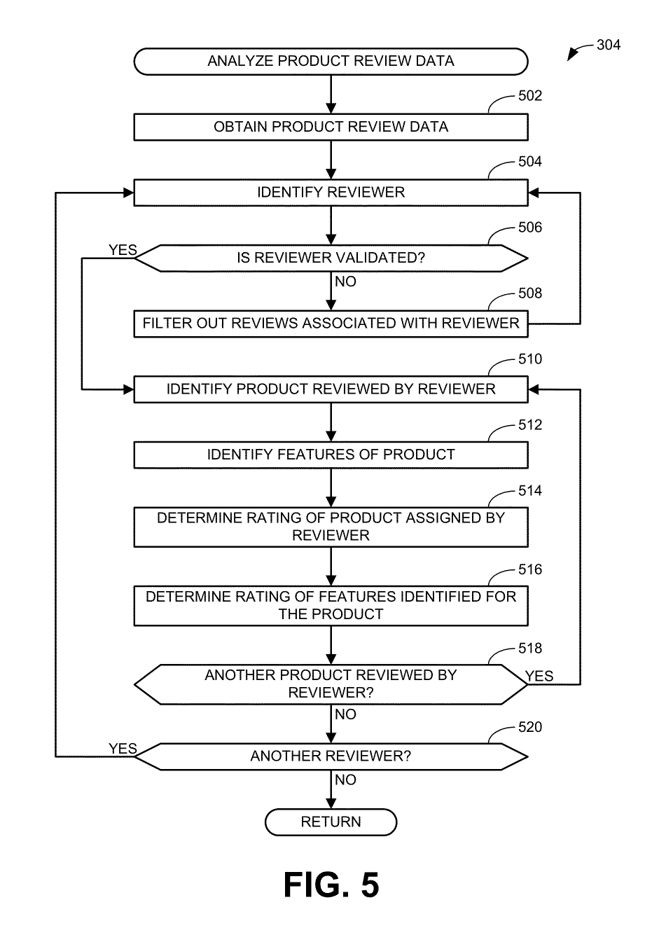

Returning to FIG. 3, at block 304, the example product review data analyzer 216 analyzes product review data. Greater detail regarding the implementation of block 304 is described in connection with FIG. 5. The example program of FIG. 5 begins at block 502 where the example product review data collector 210 obtains product review data. In some examples, the product review data is obtained from websites maintained by product review aggregator(s) 114 (e.g., via a web crawler). In some examples, the product review aggregator(s) 114 may provide the product review data to the product review data collector 210. At block 504, the example product review data analyzer 216 identifies a reviewer. At block 506, the example reviewer validator 214 determines whether the reviewer is validated. If the example reviewer validator 214 determines the reviewer is not validated, control advances to block 508 where the example review validator 214 filters out reviews associated with the identified reviewer. Control then returns to block 504 to identify another reviewer. If the example reviewer validator 214 determines the reviewer is validated (block 506), control advances to block 510.

At block 510, the example product review data analyzer 216 identifies a product reviewed by the reviewer. At block 512, the example product review data analyzer 216 identifies features of the product. In some examples, the features are identified based upon an analysis of UPC and/or other product description information. In some examples, the features are identified based on a look up of the identified product in the product feature database 208 in which the features previously identified have been stored. Additionally, in some examples, the features are identified based on a textual analysis of the comments included by the review in the review of the product. At block 514, the example product review data analyzer 216 determines the rating of the product assigned by the reviewer. At block 516, the example product review data analyzer 216 determines the rating of the features identified for the product.

At block 518, the example product review data analyzer 216 determines whether there is another product reviewed by the reviewer. If so, control returns to block 510. If the example product review data analyzer 216 determines that there are no more products reviewed by the reviewer to analyze, control advance to block 520. At block 520, the example product review data analyzer 216 determines whether there is another reviewer to analyze. If so, control returns to block 504. Otherwise, the example program of FIG. 5 ends and returns to the program of FIG. 3.

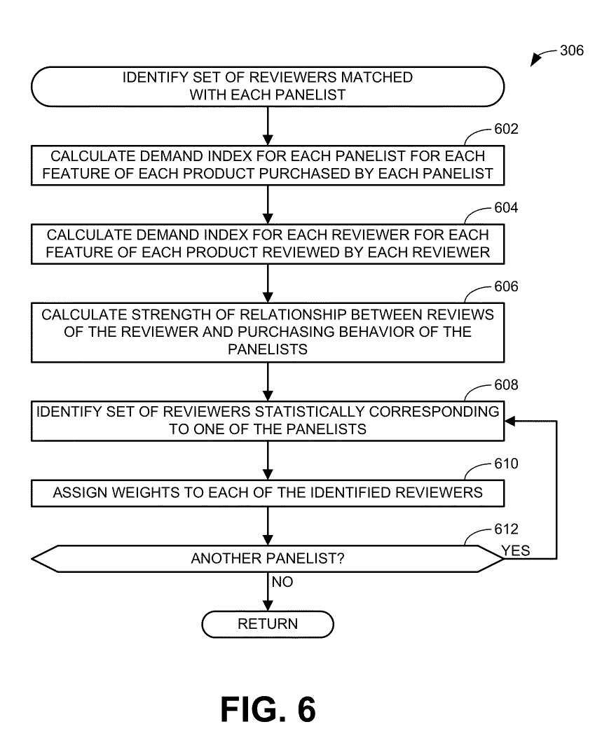

Returning the FIG. 3, at block 306, the example predictive reviewer set identifier 222 identifies a set of reviewers matched with or otherwise statistically related to each of the panelists. Greater detail regarding the implementation of block 306 is described in connection with FIG. 6. The example program of FIG. 6 begins at block 602 where the example demand calculator 218 calculates a demand index for each panelist for each feature of each product purchased by each panelist. At block 604, the example demand calculator 218 calculates a demand index for each reviewer for each feature of each product reviewed by each reviewer. In some examples, the demand calculator additionally or alternatively calculates a demand index for the products themselves purchased or reviewed by the panelists and reviewers respectively.

At block 606, the example relationship analyzer 220 calculates a strength of relationship (e.g., a strength of correlation) between the reviews of the reviewers and the purchasing behavior of the panelists. At block 608, the example predictive reviewer set identifier 222 identifies a set of reviewers statistically corresponding to (or otherwise matching) one of the panelists. At block 610, the example predictive reviewer set identifier 222 assigns weights to each of the identified reviewers. At block 612, the example predictive reviewer set identifier 222 determines whether there is another panelist for which a set of reviewers is to be identified. If so, control returns to block 608. Otherwise, the example program of FIG. 6 ends and returns to the program of FIG. 3.

Returning to FIG. 3, at block 308, the example attitude predictor 224 predicts the attitude of the panelists. At block 310, the example market analyzer 226 extrapolates the predictions for the panelists to broader population(s). At block 312, the example program determines whether there is more data. If so, control returns to block 302. Otherwise, the example program of FIG. 3 ends.

FIG. 7 is a block diagram of an example processor platform 700 capable of executing the instructions of FIGS. 3-6 to implement the data processing facility 17 of FIG. 2. The processor platform 700 can be, for example, a server, a personal computer, a mobile device (e.g., a cell phone, a smart phone, a tablet such as an iPad™), a personal digital assistant (PDA), an Internet appliance, or any other type of computing device.

The processor platform 700 of the illustrated example includes a processor 712. The processor 712 of the illustrated example is hardware. For example, the processor 712 can be implemented by one or more integrated circuits, logic circuits, microprocessors or controllers from any desired family or manufacturer.

The processor 712 of the illustrated example includes a local memory 713 (e.g., a cache). In the illustrated example, the processor 912 implements the example purchasing behavior data collector 202, the example purchasing behavior data analyzer 206, the example product review data collector 210, the example reviewer validator 214, the example product review data analyzer 216, the example demand calculator 218, the example relationship analyzer 220, the example predictive reviewer set identifier 222, the example attitude predictor 224, and/or the example market analyzer 226 of FIG. 2. The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), and/or a PCI express interface.

In the illustrated example, one or more input devices 722 are connected to the interface circuit 720. The input device(s) 722 permit(s) a user to enter data and commands into the processor 712. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 720 of the illustrated example, thus, typically includes a graphics driver card, a graphics driver chip or a graphics driver processor.

The interface circuit 720 of the illustrated example also includes a communication device such as a transmitter, a receiver, a transceiver, a modem and/or network interface card to facilitate exchange of data with external machines (e.g., computing devices of any kind) via a network 726 (e.g., an Ethernet connection, a digital subscriber line (DSL), a telephone line, coaxial cable, a cellular telephone system, etc.).

The processor platform 700 of the illustrated example also includes one or more mass storage devices 728 for storing software and/or data. For example, the mass storage device 728 may include the example purchasing behavior data database 204, the example product feature database 208, and/or the example product review data database. Examples of such mass storage devices 728 include floppy disk drives, hard drive disks, compact disk drives, Blu-ray disk drives, RAID systems, and digital versatile disk (DVD) drives.

The coded instructions 732 of FIGS. 3-6 may be stored in the mass storage device 728, in the volatile memory 714, in the non-volatile memory 716, and/or on a removable tangible computer readable storage medium such as a CD or DVD.

From the foregoing, it will appreciate that the above disclosed methods, apparatus and articles of manufacture provide a reliable and cost effective way to determine the attitudes, preferences, and/or sentiments of consumers in a market research panel. More particularly, the examples disclosed herein facilitate the acquisition of attitudinal input without having to elicit feedback panelists to explain the reasons of the purchases. Further, the examples disclosed herein avoid the time and expense involved in seeking feedback from other consumers by way of surveys and/or focus groups as has commonly been implemented in the past. Specifically, this is made possible by taking advantage of the wide proliferation of online product reviews in which the sentiments of actual purchasers (the reviewers) provide indication of their attitudes including what and how much they like or don't like certain products and/or product features. Such information is readily available online and can be retrieved at very little cost. By integrating this data with panelist-based purchasing behavior data through statistical analysis, the attitudes of the reviewers can be imputed to the panelists for marketing analysis. Not only are the examples disclosed herein much more cost effective than known alternatives such as surveys and focus groups, because online reviews are based on actual purchasers rather than hypothetically based responses, the results of such studies can be much more robust and reliable.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method, comprising:
obtaining purchasing behavior data associated with a consumer;
obtaining product review data associated with a plurality of reviewers;
identifying a set of reviewers from the plurality of reviewers based on a strength of relationship between each of the plurality of reviewers and the consumer; and
predicting, using a processor, an attitude of the consumer based on the product review data associated with the set of reviewers.

2. The method of claim 1, further comprising assigning a weight to each reviewer of the set of reviewers based on the strength of relationship between each of the plurality of reviewers and the consumer.

3. The method of claim 1, further comprising:
identifying product ratings assigned by the plurality of reviewers to reviewed products based on the product review data;
identifying at least one of a quantity or a price of products purchased by the consumer based on the purchasing behavior data; and
determining the strength of relationship between each of the plurality of reviewers and the consumer based on the product ratings and the at least one of the quantity or the price.

4. The method of claim 1, further comprising:
identifying feature ratings assigned by the plurality of reviewers to features of reviewed products based on the product review data; and
determining the strength of relationship between each of the plurality of reviewers and the consumer based on the feature ratings.

5. The method of claim 4, wherein the set of reviewers corresponds to a first set of reviewers when the strength of relationship is determined relative to a first one of the features of the reviewed products, the set of reviewers corresponding to a second set of reviewers different than the first set of reviewers when the strength of relationship is determined relative to a second one of the features of the reviewed products.

6. The method of claim 4, wherein the features correspond to concepts associated with the reviewed products as identified by the plurality of reviewers.

7. The method of claim 4, wherein the attitude of the consumer is predicted based on the features of the reviewed products as identified by the plurality of reviewers.

8. The method of claim 1, further comprising predicting the attitude of the consumer with respect to a product previously purchased by the consumer.

9. The method of claim 1, further comprising predicting the attitude of the consumer with respect to a reviewed product not previously purchased by the consumer.

10. The method of claim 1, further comprising predicting the attitude of the consumer with respect to a product not previously purchased by the consumer and not previously reviewed by the set of reviewers.

11. The method of claim 1, further comprising identifying a marketing segment for at least one of a product or a product feature based on the attitude of the consumer.

12. An apparatus comprising
a purchasing behavior data collector to obtain purchasing behavior data associated with a consumer;
a product review data collector to obtain product review data associated with a plurality of reviewers;
a predictive reviewer set identifier to identify a set of reviewers from the plurality of reviewers based on a strength of relationship between each of the plurality of reviewers and the consumer; and
an attitude predictor, implemented via a processor, to predict an attitude of the consumer based on the product review data associated with the set of reviewers.

13. The apparatus of claim 12, wherein the predictive reviewer set identifier is to assign a weight to each reviewer of the set of reviewers based on the strength of relationship between each of the plurality of reviewers and the consumer.

14. The apparatus of claim 12, further comprising:
a product review data analyzer to identify product ratings assigned by the plurality of reviewers to reviewed products based on the product review data;
a purchasing behavior data analyzer to identify at least one of a quantity or a price of products purchased by the consumer based on the purchasing behavior data; and
a relationship analyzer to determine the strength of relationship between each of the plurality of reviewers and the consumer based on the product ratings and the at least one of the quantity or the price.

15. The apparatus of claim 12, further comprising:
a product review data analyzer to identify feature ratings assigned by the plurality of reviewers to features of reviewed products based on the product review data; and
a relationship analyzer to determine the strength of relationship between each of the plurality of reviewers and the consumer based on the feature ratings.

16. The apparatus of claim 15, wherein the set of reviewers corresponds to a first set of reviewers when the strength of relationship is determined relative to a first one of the features of the reviewed products, the set of reviewers corresponding to a second set of reviewers different than the first set of reviewers when the strength of relationship is determined relative to a second one of the features of the reviewed products.

17. The apparatus of claim 15, wherein the features correspond to concepts associated with the reviewed products as identified by the plurality of reviewers.

18. The apparatus of claim 15, wherein the attitude predictor is to predict the attitude of the consumer based on the features of the reviewed products as identified by the plurality of reviewers.

19. The apparatus of claim 12, wherein the attitude predictor is to predict the attitude of the consumer with respect to a product previously purchased by the consumer.

20. The apparatus of claim 12, wherein the attitude predictor is to predict the attitude of the consumer with respect to a reviewed product not previously purchased by the consumer.

21. The apparatus of claim 12, wherein the attitude predictor is to predict the attitude of the consumer with respect to a product not previously purchased by the consumer and not previously reviewed by the set of reviewers.

22. The apparatus of claim 12, further comprising a market analyzer to identify a marketing segment for at least one of a product or a product feature based on the attitude of the consumer.

23. A tangible computer readable storage medium comprising instructions that, when executed, cause a machine to at least:
obtain purchasing behavior data associated with a consumer;
obtain product review data associated with a plurality of reviewers;
identify a set of reviewers from the plurality of reviewers based on a strength of relationship between each of the plurality of reviewers and the consumer; and
predict an attitude of the consumer based on the product review data associated with the set of reviewers.

24. The storage medium of claim 23, wherein the instructions further cause the machine to assign a weight to each reviewer of the set of reviewers based on the strength of relationship between each of the plurality of reviewers and the consumer.

25. The storage medium of claim 23, wherein the instructions further cause the machine to:
identify product ratings assigned by the plurality of reviewers to reviewed products based on the product review data;
identify at least one of a quantity or a price of products purchased by the consumer based on the purchasing behavior data; and
determine the strength of relationship between each of the plurality of reviewers and the consumer based on the product ratings and the at least one of the quantity or the price.

26. The storage medium of claim 23, wherein the instructions further cause the machine to:
identify feature ratings assigned by the plurality of reviewers to features of reviewed products based on the product review data; and
determine the strength of relationship between each of the plurality of reviewers and the consumer based on the feature ratings.

27. The storage medium of claim 26, wherein the set of reviewers corresponds to a first set of reviewers when the strength of relationship is determined relative to a first one of the features of the reviewed products, the set of reviewers corresponding to a second set of reviewers different than the first set of reviewers when the strength of relationship is determined relative to a second one of the features of the reviewed products feature.

28. The storage medium of claim 26, wherein the features correspond to concepts associated with the reviewed products as identified by the plurality of reviewers.

29. The storage medium of claim 26, wherein the instructions further cause the machine to predict the attitude of the consumer based on the features of the reviewed products as identified by the plurality of reviewers.

30. The storage medium of claim 23, wherein the instructions further cause the machine to predict the attitude of the consumer with respect to a product previously purchased by the consumer.

31. The storage medium of claim 23, wherein the instructions further cause the machine to predict the attitude of the consumer with respect to a reviewed product not previously purchased by the consumer.

32. The storage medium of claim 23, wherein the instructions further cause the machine to predict the attitude of the consumer with respect to a product not previously purchased by the consumer and not previously reviewed by the set of reviewers.

33. The storage medium of claim 23, wherein the instructions further cause the machine to identify a marketing segment for at least one of a product or a product feature based on the attitude of the consumer.
